(19) United States
(12) Patent Application Publication
(10) Pub. No.: US 2025/0079538 A1
(43) Pub. Date: Mar. 6, 2025

(54) ELECTRONIC DEVICE AND BATTERY MANAGEMENT METHOD THEREOF

(71) Applicant: ASUSTeK COMPUTER INC., Taipei City (TW)

(72) Inventors: Chunyen Lai, Taipei City (TW); Chun Tsao, Taipei City (TW); Wen-Che Chung, Taipei City (TW); Ying-Yui Wu, Taipei City (TW)

(73) Assignee: ASUSTeK COMPUTER INC., Taipei City (TW)

(21) Appl. No.: 18/673,320

(22) Filed: May 24, 2024

(30) Foreign Application Priority Data
Aug. 31, 2023 (TW) 112132946

(51) Int. Cl. H01M 10/42; H01M 10/48; H02J 7/00

(52) U.S. Cl. CPC H01M 10/425; H01M 10/486; H02J 7/00302; H02J 7/00712; H02J 7/007194; H01M 2010/4271; H01M 2220/30

(57) ABSTRACT

An electronic device and a battery management method thereof are provided. The method includes the following. A battery learning enable command is received to execute a battery learning operation. During an execution period of the battery learning operation, usage record data of a battery module is analyzed to obtain usage situation information. An appropriate value of a charging limit capacity is determined based on the usage situation information.

### CROSS-REFERENCE TO RELATED APPLICATION

This application claims the priority benefit of Taiwan application serial no. 112132946, filed on Aug. 31, 2023. The entirety of the above-mentioned patent application is hereby incorporated by reference herein and made a part of this specification.

### BACKGROUND

### Technical Field

The invention relates to an electronic device adapted to actively adjust a charging limit capacity while considering usage habits and a battery management method thereof.

### Description of Related Art

In today's handheld electronic products (such as notebook computers, mobile phones, digital cameras or tablet computers), battery plays an important role in power supply. However, if a power adapter (such as an AC adapter) is plugged in an electronic product for a long time, the battery will remain fully charged for a long time, resulting in accelerated battery aging and thus affecting a user experience.

### SUMMARY

The invention provides a battery management method adapted to an electronic device including a battery module. The method includes following steps: receiving a battery learning enable command to execute a battery learning operation; during an execution period of the battery learning operation, analyzing usage record data of the battery module to obtain usage situation information; and determining an appropriate value of a charging limit capacity based on the usage situation information.

The invention further provides an electronic device including a battery module and a controller. The battery module includes a battery cell pack, a storage block and a control circuit. The storage block stores usage record data. The control circuit is coupled to the battery cell pack and the storage block, and is configured to receive a battery learning enable command to execute the battery learning operation. During an execution period of the battery learning operation, the control circuit analyzes the usage record data of the battery module to obtain usage situation information, and determines an appropriate value of a charging limit capacity based on the usage situation information.

Based on the above description, the electronic device and the battery management method thereof are adapted to execute a battery learning operation to analyze the usage record data of the battery module, and determine the appropriate value of the charging limit capacity based on the usage situation information obtained through analysis. In this way, the charging limit capacity of the battery module may be actively adjusted according to the determined appropriate value, so as to slow down battery aging when the electronic device is powered on for a long time and provide a better usage experience.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block schematic diagram of an electronic device according to an embodiment of the invention.

FIG. 2 is a flowchart of a battery management method according to an embodiment of the invention.

FIG. 3 is a flowchart of a battery management method according to an embodiment of the invention.

FIG. 4 is a flowchart of a battery management method according to an embodiment of the invention.

FIG. 5 is a flowchart of a battery management method according to an embodiment of the invention.

### DESCRIPTION OF THE EMBODIMENTS

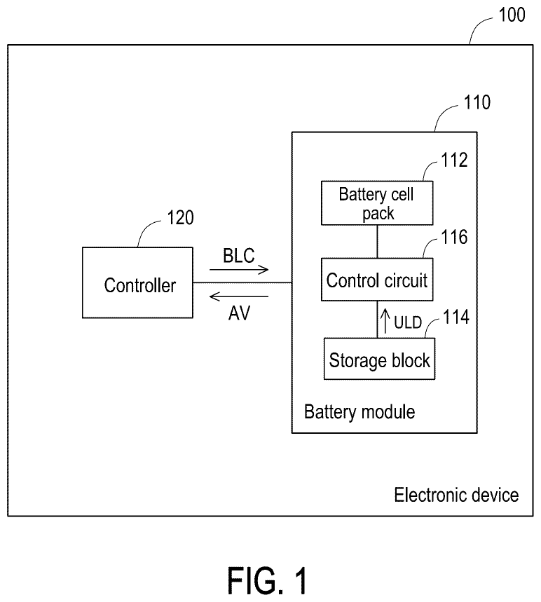

Referring to FIG. 1, the electronic device 100 of the embodiment is, for example, a handheld electronic product such as a notebook computer, a mobile phone, a digital camera, or a tablet computer, etc. The electronic device 100 includes a battery module 110 and a controller 120.

The battery module 110 may be used to power the electronic device 100, and may be a built-in type or an external type. The battery module 110 includes a battery cell pack 112, a storage block 114 and a control circuit 116. The battery cell pack 112 is, for example, composed of a single or a plurality of battery cells (battery cell monomers). The storage block 114 includes, for example, a plurality of registers, which may be any type of random access memory (RAM), read-only memory (ROM), or flash memory, or a combination of the above elements. The storage block 114 may be used to store usage record data ULD of the battery module 110. For example, the usage record data ULD includes a plurality of characteristic values of the battery module 110 recorded in a time sequence (for example, a plurality of temperature values, a plurality of charging voltage values, a plurality of charging current values, etc.). According to the usage record data ULD, the user's usage habits of the electronic device 100 may be learned (such as long-term use without interruption or continuous high-energy-consuming operations such as three-dimensional image processing, etc.)

The control circuit 116 is coupled to the battery cell pack 112 and the storage block 114. The control circuit 116 includes, for example, a battery gauge IC or a microcontroller, which may be used to receive a battery learning enable command BLC to execute a battery learning operation. In addition, during an execution period of the battery learning operation, the control circuit 116 may record the characteristic values (such as a temperature value, a charging voltage value, a charging current value, etc.) of the battery module 110 in the storage block 114 at predetermined intervals for using multiple registers to record the multiple characteristic values of the battery module 110 in time sequence.

The controller 120 is coupled to the battery module 110. The controller 120 is, for example, an embedded controller (EC) or a microcontroller that may communicate with the battery module 110 through a communication protocol, and may be used to set a charging limit capacity of the battery module 110. For example, when the electronic device 100 is connected to a power adapter and the charging limit capacity is set to 80%, charging will stop once the battery module 110 is charged to 80%, so as to maintain the power of the battery module 110 at 80%, thereby preventing the battery module 110 from being in a full power state. The communication protocol in the embodiment is, for example, system management bus (SMBus) or inter-integrated circuit (I²C), but the embodiment is not limited thereto.

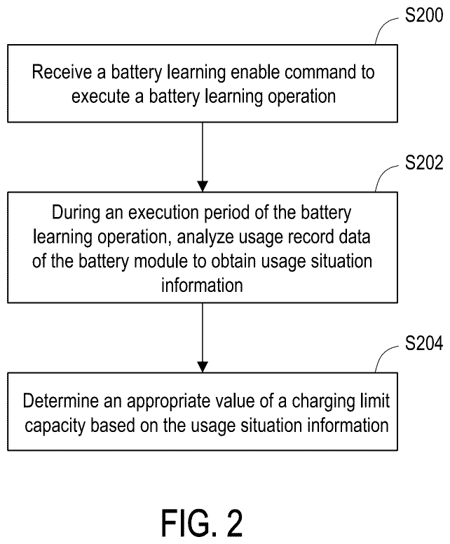

The following examples illustrate detailed steps of a battery management method of the invention. Referring to FIG. 1 and FIG. 2 at the same time, the battery management method of the embodiment may be applied to the electronic device 100 of FIG. 1, and the steps are described as follows:

First, in step S200, the control circuit 116 receives the battery learning enable command BLC from the controller 120 to execute a battery learning operation. Specifically, when a user turns on a battery learning function through an application related to power management, the controller 120 may output the battery learning enable command BLC to the control circuit 116. When the electronic device 100 is in a powered state, the control circuit 116 that receives the battery learning enable command BLC may enter a battery care mode to start executing the battery learning operation by using a machine learning technology.

Then, in step S202, during the execution period of the battery learning operation, the control circuit 116 analyzes the usage record data ULD of the battery module 110 to obtain usage situation information. Specifically, the control circuit 116 may read the usage record data ULD from the storage block 114. Since the usage record data ULD includes a plurality of characteristic values (such as a plurality of temperature values, a plurality of charging voltage values or a plurality of charging current values, etc.) of the battery module 110 recorded in a time sequence, the control circuit 116 may analyze the usage record data ULD to determine which usage situation the battery module 110 is currently stable in, and then summarize the user's usage habits of the electronic device 100. For example, the control circuit 116 may determine that the battery module 110 is stably operating in a normal situation, an overheating situation in which a temperature is continuously greater than a temperature threshold, or an overloading situation in which a charging voltage is continuously greater than a voltage threshold, and take a determination result as the usage situation information reflecting the usage habits.

Finally, in step S204, the control circuit 116 determines an appropriate value AV of the charging limit capacity based on the usage situation information. For example, when the battery module 110 is stably in the overheating situation or the overloading situation, the control circuit 116 may set the appropriate value AV of the charging limit capacity to a first percentage. When the battery module 110 is stably in the normal situation, the control circuit 116 may set the appropriate value AV of the charging limit capacity to a second percentage. In the embodiment, the second percentage is, for example, a predetermined value of the charging limit capacity of the battery module 110, and the second percentage is greater than the first percentage. In other words, when the battery module 110 is stably in the overheating situation or the overloading situation, the appropriate value AV of the charging limit capacity will be reduced. In this way, the controller 120 may provide the determined appropriate value AV to a basic input/output system (BIOS) to actively adjust the charging limit capacity of the battery module 110 according to the appropriate value AV so that it may conform to the usage habits to achieve a battery maintenance effect.

It should be noted that since the battery management method of the invention mainly adjusts the charging limit capacity of the battery module 110, it is usually executed during a chargeable period when the electronic device 100 is in a powered state.

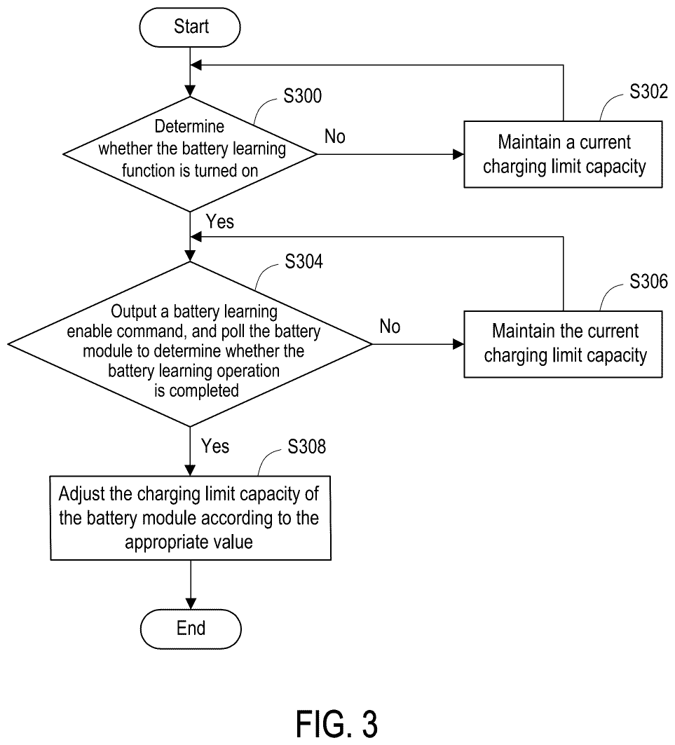

The following is another embodiment to describe a battery management method of the invention in detail. Referring to FIG. 1 and FIG. 3 at the same time, the battery management method of the embodiment is adapted to the controller 120 in the electronic device 100 of FIG. 1, and the steps are described as follows:

First, in step S300, the controller 120 determines whether the battery learning function is turned on. For example, the controller 120 may determine whether the battery learning function is turned on according to settings in an application related to power management. When the battery learning function is not turned on, in step S302, the controller 120 maintains the current charging limit capacity, and then returns to step S300 to continue the judgment.

When the battery learning function is turned on, in step S304, the controller 120 outputs the battery learning enable command BLC to the battery module 110, and polls the battery module 110 to determine whether the battery learning operation is completed. Specifically, the controller 120 may query the battery module 110 every a fixed period (for example, 1 second) whether it has completed the battery learning operation and generate the appropriate value AV of the charging limit capacity that is complied with the current usage habits. When the battery learning operation is not completed, the controller 120 maintains the existing charging limit capacity in step S306, and then returns to step S304 to continue the judgment.

When the battery learning operation is completed, in step S308, the controller 120 adjusts the charging limit capacity of the battery module 110 according to the appropriate value AV. For example, when the appropriate value AV is the first percentage, the controller 120 may provide the first percentage to the BIOS to set the charging limit capacity to the first percentage. When the appropriate value AV is the second percentage, the controller 120 may provide the second percentage to the BIOS to set the charging limit capacity to the second percentage.

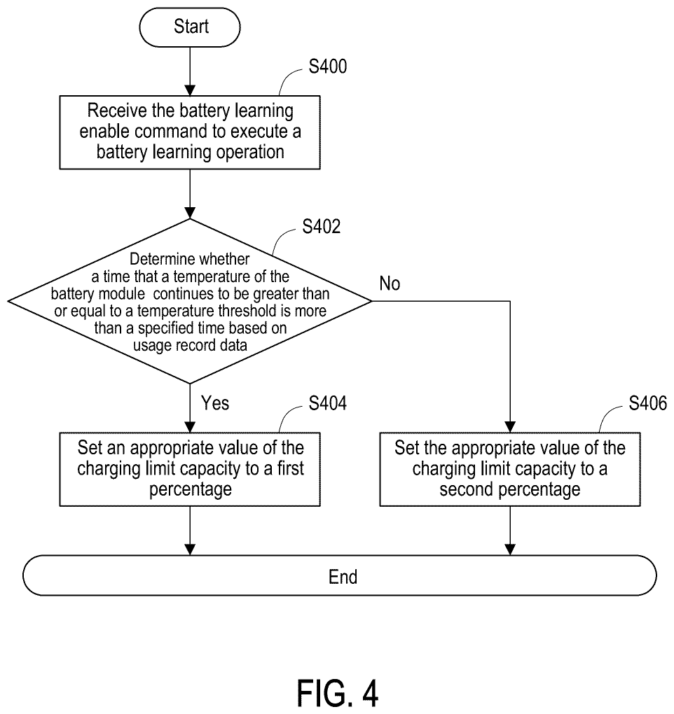

In an embodiment, the control circuit 116 may analyze a plurality of temperature values of the battery module 110 recorded in a time sequence in the usage record data ULD to determine which usage situation the battery module 110 is currently stable in. In details, referring to FIG. 1 and FIG. 4 at the same time, the battery management method of the embodiment is suitable for the battery module 110 in the electronic device 100 of FIG. 1. The steps of the method are described as follows:

First, in step S400, the control circuit 116 receives the battery learning enable command BLC from the controller 120 to execute a battery learning operation.

Then, in step S402, the control circuit 116 determines whether a time that the temperature of the battery module 110 continues to be greater than or equal to a temperature threshold (for example, 40 degrees) is more than a specified time based on the usage record data ULD.

When the time that the temperature of the battery module 110 continues to be greater than or equal to the temperature threshold is more than a specified time, it means that the battery module 110 is stably in an overheating situation. In step S404, the control circuit 116 sets the appropriate value AV of the charging limit capacity to the first percentage.

When the time that the temperature of the battery module 110 continues to be greater than or equal to the temperature threshold is not more than the specified time, it means that the battery module 110 is stably in the normal situation. In step S406, the control circuit 116 sets the appropriate value AV of the charging limit capacity to the second percentage (the second percentage is greater than the first percentage).

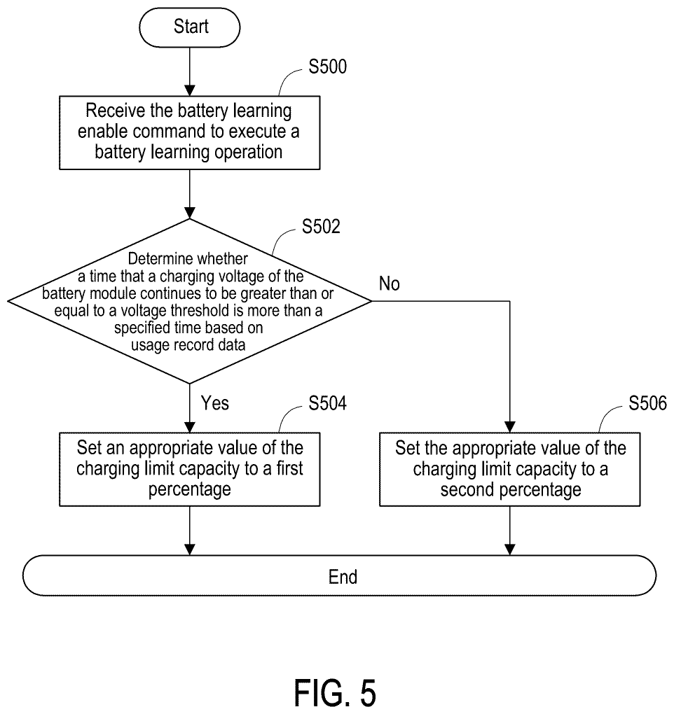

In an embodiment, the control circuit 116 may analyze a plurality of charging voltage values of the battery module 110 recorded in the usage record data ULD in a time sequence to determine which usage situation the battery module 110 is currently stable in. In detail, referring to FIG. 1 and FIG. 5 at the same time, the battery management method of the embodiment is applicable to the battery module 110 in the electronic device 100 of FIG. 1, the steps of the method are described as follows:

First, in step S500, the control circuit 116 receives the battery learning enable command BLC from the controller 120 to execute a battery learning operation.

Then, in step S502, the control circuit 116 determines whether a time that a charging voltage of the battery module 110 continues to be greater than or equal to a voltage threshold (for example, 4 volts) is more than a specified time based on the usage record data ULD.

When the time that the charging voltage of the battery module 110 continues to be greater than or equal to the voltage threshold is more than the specified time, it means that the battery module 110 is stably in the overloading situation. In step S504, the control circuit 116 sets the appropriate value AV of the charging limit capacity to first percentage.

When time that the charging voltage of the battery module 110 continues to be greater than or equal to the voltage threshold is not more than the specified time, it means that the battery module 110 is stably in the normal situation. In step S506, the control circuit 116 sets the appropriate value AV of the charging limit capacity to the second percentage (the second percentage is greater than the first percentage).

It should be noted that, in an embodiment, the control circuit 116 may also simultaneously analyze the plurality of temperature values and the plurality of charging voltage values of the battery module 110 recorded in the usage record data ULD in the time sequence, and when the time that the charging voltage of the battery module 110 continues to be greater than or equal to the voltage threshold value or the time that the temperature of the battery module 110 continues to be greater than or equal to the temperature threshold is more than the specified time, the appropriate value AV of the charging limit capacity is set to the first percentage.

In summary, the electronic device and the battery management method of the invention may execute the battery learning operation to analyze the usage record data of the battery module to obtain the appropriate value of the charging limit capacity. In this way, the charging limit capacity of the battery module may be actively adjusted according to the appropriate value that conforms to usage habits, so as to slow down battery aging when the electronic device is powered on for a long time, and provide a better usage experience.

What is claimed is:

1. A battery management method, adapted to an electronic device comprising a battery module, wherein the battery management method comprises:
receiving a battery learning enable command to execute a battery learning operation;
during an execution period of the battery learning operation, analyzing usage record data of the battery module to obtain usage situation information; and
determining an appropriate value of a charging limit capacity based on the usage situation information.

2. The battery management method as claimed in claim 1, further comprising:
determining whether a battery learning function is turned on;
in response to the battery learning function being turned on, outputting the battery learning enable command, and polling the battery module to determine whether the battery learning operation is completed; and
in response to the battery learning operation being completed, adjusting the charging limit capacity of the battery module according to the appropriate value.

3. The battery management method as claimed in claim 1, wherein the usage record data comprises a plurality of temperature values of the battery module recorded in a time sequence, and analyzing the usage record data of the battery module to obtain the usage situation information comprises:
determining whether a time that a temperature of the battery module continues to be greater than or equal to a temperature threshold is more than a specified time based on the usage record data; and
taking a determination result as the usage situation information.

4. The battery management method as claimed in claim 3, wherein determining the appropriate value of the charging limit capacity based on the usage situation information comprises:
in response to the time that the temperature of the battery module continues to be greater than or equal to the temperature threshold being more than the specified time, setting the appropriate value of the charging limit capacity to a first percentage; and
in response to the time that the temperature of the battery module continues to be greater than or equal to the temperature threshold not being more than the specified time, setting the appropriate value of the charging limit capacity to a second percentage, wherein the second percentage is greater than the first percentage.

5. The battery management method as claimed in claim 1, wherein the usage record data comprises a plurality of charging voltage values of the battery module recorded in a time sequence, and analyzing the usage record data of the battery module to obtain the usage situation information comprises:
determining whether a time that a charging voltage of the battery module continues to be greater than or equal to a voltage threshold is more than a specified time based on the usage record data; and
taking a determination result as the usage situation information.

6. The battery management method as claimed in claim 5, wherein determining the appropriate value of the charging limit capacity based on the usage situation information comprises:
in response to the time that the charging voltage of the battery module continues to be greater than or equal to the voltage threshold being more than the specified time, setting the appropriate value of the charging limit capacity to a first percentage; and
in response to the time that the charging voltage of the battery module continues to be greater than or equal to the voltage threshold not being more than the specified time, setting the appropriate value of the charging limit capacity to a second percentage, wherein the second percentage is greater than the first percentage.

7. An electronic device, comprising:
a battery module, comprising a battery cell pack, a storage block, and a control circuit, wherein the storage block stores usage record data, the control circuit is coupled to the battery cell pack and the storage block, and is configured to receive a battery learning enable command to execute a battery learning operation; and
a controller, coupled to the battery module, and configured to set a charging limit capacity of the battery module,
wherein during an execution period of the battery learning operation, the control circuit analyzes the usage record data of the battery module to obtain usage situation information, and determines an appropriate value of the charging limit capacity based on the usage situation information.

8. The electronic device as claimed in claim 7, wherein the controller determines whether a battery learning function is turned on;
in response to the battery learning function being turned on, the controller outputs the battery learning enable command to the control circuit, and polls the battery module to determine whether the battery learning operation is completed; and
in response to the battery learning operation being completed, the controller adjusts the charging limit capacity of the battery module according to the appropriate value.

9. The electronic device as claimed in claim 7, wherein the usage record data comprises a plurality of temperature values of the battery module recorded in a time sequence,
the controller determines whether a time that a temperature of the battery module continues to be greater than or equal to a temperature threshold is more than a specified time based on the usage record data, and takes a determination result as the usage situation information.

10. The electronic device as claimed in claim 9, wherein in response to the time that the temperature of the battery module continues to be greater than or equal to the temperature threshold being more than the specified time, the control circuit sets the appropriate value of the charging limit capacity to a first percentage; and
in response to the time that the temperature of the battery module continues to be greater than or equal to the temperature threshold not being more than the specified time, the control circuit sets the appropriate value of the charging limit capacity to a second percentage, wherein the second percentage is greater than the first percentage.

11. The electronic device as claimed in claim 7, wherein the usage record data comprises a plurality of charging voltage values of the battery module recorded in a time sequence,
the control circuit determines whether a time that a charging voltage of the battery module continues to be greater than or equal to a voltage threshold is more than a specified time based on the usage record data, and takes a determination result as the usage situation information.

12. The electronic device as claimed in claim 11, wherein in response to the time that the charging voltage of the battery module continues to be greater than or equal to the voltage threshold being more than the specified time, the control circuit sets the appropriate value of the charging limit capacity to a first percentage; and
in response to the time that the charging voltage of the battery module continues to be greater than or equal to the voltage threshold not being more than the specified time, the control circuit sets the appropriate value of the charging limit capacity to a second percentage, wherein the second percentage is greater than the first percentage.
